(19) United States
(12) Patent Application Publication
(10) Pub. No.: US 2026/0225682 A1
(43) Pub. Date: Aug. 6, 2026

(54) A MECHANICAL AUXILIARY DEVICE FOR STABILIZATION OF FREE TILTING SUSPENSION VEHICLES

(71) Applicant: Eyal RESLER, Tel-Aviv (IL)

(72) Inventor: Eyal RESLER, Tel-Aviv (IL)

(21) Appl. No.: 19/157,486

(22) PCT Filed: Mar. 7, 2024
(86) PCT No.: PCT/IL2024/050250

§ 371 Date: Aug. 18, 2025

Related U.S. Application Data
(60) Provisional application No. 63/451,014, filed on Mar. 9, 2023.

(51) Int. Cl. B62K 25/24; B62K 5/00

(52) U.S. Cl. CPC B62K 25/24; B62K 2005/001

(57) ABSTRACT

A mechanical auxiliary device for stabilization of free tilting suspension vehicles. The mechanical auxiliary device comprises:
a transverse shaft mounted on the vehicle body. The transverse shaft is oriented transversely to the vehicle longitudinal direction,
a first, right, torque arm and a second, left, torque arm each connected to opposite ends of the transverse shaft,
a first, right, primed spring-type element connected at its proximal end to the first, right, torque arm, and a second, left, primed spring-type element connected at its proximal end to the second, left, torque arm, the first, right primed spring-type element is connected at its distal end to a first, right, suspension arm, and the second, left, primed spring-type element is connected at its distal end to a second, left, suspension arm, the first primed spring-type element and the second primed spring-type element are approximately vertically oriented to the transverse shaft.

### FIELD OF THE INVENTION

The present invention relates to roll control devices for vehicles. More specifically, the present invention relates to a device for stabilizing the roll movement of vehicles.

### BACKGROUND OF THE INVENTION

A stabilizer reduces the rolling of the vehicle, provided the stabilizer is not restricted in its action, so that the rolling angle is reducable during cornering. For adequate anti-rolling action, a high rigidity of the stabilizer is necessary.

Many stabilizer bars are U-shaped members having a central, transversely-mounted section and a pair of longitudinally-projecting arms connected to respective wheel supports, usually a control arm pivotally connected to a chassis rail.

Often, either a rigid or flexible end link is connected between a control arm and a stabilizer bar. When the control arm moves as a result of a road input, the end link transmits all or part of the movement to the stabilizer bar. The spring-effect of the stabilizer bar is then transmitted through an opposite end link to a control arm on the other side of the vehicle to resist the rolling motion of the vehicle.

Over the years researchers have exerted effort to control vehicle roll motion by using various control strategies. These studies have improved vehicle roll motion behavior with various control schemes. For instance, US Patent Application No. 20040173985A1 describes a device intended to minimize the roll movement of vehicle bodies having rigid axles or independent suspensions, with a non-torsion bar mounted pivotably on the vehicle body and oriented approximately transversely to the vehicle longitudinal direction, and two parallel cantilever arms disposed approximately horizontally in a neutral position of the vehicle, essentially vertically oriented spring/damper units are supported between free ends of the cantilever arms and the vehicle wheel suspensions, the spring/damper units being cylinder/piston units filled with a hydraulic fluid, with the pistons in the cylinder/piston units being centered, free of play, so as to be pre-stressed between springs.

Unlike other active suspension systems that use active hydraulic pistons connected to a flexible stabilizer bar whose flexibility reduces the accuracy of those systems, the device of US Patent Application No. 2004/0173985 shown in FIGS. 1A and 1B (PRIOR-ART) does not use a flexible stabilizer bar (torsion bar). Instead, it replaces the spring assist of a “classic” stabilizer bar with two pairs of coil springs inside the pistons (40).

When the hydraulic system is activated, it produces an active force that cancels the action of the springs, thus, allowing full and accurate correction of the roll angle.

The device of US Patent Application No. 2004/0173985 uses a rigid stabilizer rod which fully and accurately controls the relationship between the right side and the left side when activating the hydraulic system and enables a more precise operation that does not compromise the flexibility of the torsion bar.

However, the disadvantage of the device of US Patent Application No. 2004/0173985 lies in the pistons (40) as each of these pistons includes two springs arranged opposite each other, therefore, there is no “locking” point at the end of the upper stroke. In other words, the two springs cancel each other out, so there is no effective locking point. Therefore, when the vehicle starts to tilt, at the beginning of the tilt, there is not enough force in the springs to provide the force necessary to stabilize the vehicle in a straight position.

Therefore, it is an aim of the present invention to provide a mechanical auxiliary device for the active stabilization of vehicles. A mechanical auxiliary device for active stabilization of vehicles that solves the critical problem of stabilizing a vehicle with a tilting mechanism in a straight position where the rider stands on it and does not lower his feet to the ground in order to stabilize it while standing, while traveling backwards, and while slowly crawling.

### SUMMARY OF THE INVENTION

The present invention describes a stabilization device for stabilizing tilting vehicles with three or more wheels with damped suspensions.

Unlike the spring/damper-based pistons described and shown in US Patent Application No. 2004/0173985, where a linear resistance to the roll angle begins and there is no effective “lock” point that can be created to keep the vehicle and the rider in a balanced-stable position while being able to tilt from side to side as needed, in the present invention, the primed spring-type elements allow the mechanism to be “locked” by a resistance force to tilt at the end of the elements' stroke when the vehicle is standing straight, for example, an effective “locking” point that can be created to keep the vehicle and the rider in a balanced-stable state while being able to tilt from side to side as needed.

In accordance with some embodiments of the present invention, there is thus provided, a mechanical auxiliary device for stabilization of free tilting suspension vehicles comprising:
a transverse shaft mounted on said vehicle body, said transverse shaft is oriented transversely to the vehicle longitudinal direction,
a first, right, torque arm and a second, left, torque arm each connected to opposite ends of said transverse shaft,
a first, right, primed spring-type element connected at its proximal end to said first, right, torque arm, and a second, left, primed spring-type element connected at its proximal end to the second, left, torque arm, said first, right primed spring-type element is connected at its distal end to a first, right, suspension arm, and said second, left, primed spring-type element is connected at its distal end to a second, left, suspension arm, said first primed spring-type element and said second primed spring-type element are approximately vertically oriented to said transverse shaft,
   wherein tilting the vehicle to the right increases an angle between the second, left, suspension arm and the vehicle body and causing the transverse shaft to rotate the first, right, torque arm clockwise in a circular motion, thus, exerting force on, and thus, pressing, the first, right, primed spring-type element, as a result of which straightening the vehicle back from a tilted position to a balanced position, and wherein tilting the vehicle to the left increases an angle between the first, right, suspension arm and the vehicle body and causing the transverse shaft to rotate the second, left, torque arm counterclockwise in a circular motion, thus, exerting force on, and thus, pressing, the second, left, primed spring-type element, as a result of which straightening the vehicle back from a tilted position to a balanced position.

Furthermore, in accordance with some embodiments of the present invention, the first, right, primed spring-type element and the second, left, primed spring-type element are selected from primed spring-type pistons and primed spring type scissors hinges.

Furthermore, in accordance with some embodiments of the present invention, each of the primed spring-type pistons is selected from a gas piston and a spring piston.

Furthermore, in accordance with some embodiments of the present invention, the first, right, primed spring-type element is connected to the first, right, torque arm through a first, right, joint connector.

Furthermore, in accordance with some embodiments of the present invention, the second, left, primed spring-type element is connected to the second, left, torque arm through a second, left, joint connector.

Furthermore, in accordance with some embodiments of the present invention, the first, right, primed spring-type element is connected at its distal end to the first, right, suspension arm by means of a third joint connector.

Furthermore, in accordance with some embodiments of the present invention, the second, left, primed spring-type element is connected at its distal end to the second, left, suspension arm by means of a forth joint connector.

Furthermore, in accordance with some embodiments of the present invention, tilting the vehicle to the right increasing the distance between the second, left, joint connector connecting the primed spring-type element to the second, left, torque arm and the forth joint connector connecting the distal end of the second, left, primed spring-type element to the suspension arm.

Furthermore, in accordance with some embodiments of the present invention, tilting the vehicle to the left increasing the distance between the first, right, joint connector connecting the primed spring-type element to the first, right, torque arm and the third joint connector connecting the distal end of the second, right, primed spring-type element to the suspension arm.

Furthermore, in accordance with some embodiments of the present invention, tilting the vehicle to the right, the second, left, primed spring-type element is open to the end of its natural stroke and cannot be extended, thus, the second, left, suspension arm pulling through the second, left, primed spring-type element the second, left, torque arm in a circular motion counterclockwise about the center of the transverse shaft.

Furthermore, in accordance with some embodiments of the present invention, tilting the vehicle to the left, the first, right, primed spring-type element is open to the end of its natural stroke and cannot be extended, thus, the first, right, suspension arm pulling through the first, right, primed spring-type element the first, right, torque arm in a circular motion clockwise about the center of the transverse shaft.

### BRIEF DESCRIPTION OF THE FIGURES

FIGS. 1A and 1B (PRIOR ART) illustrate the device of US Patent Application No. 2004/0173985.

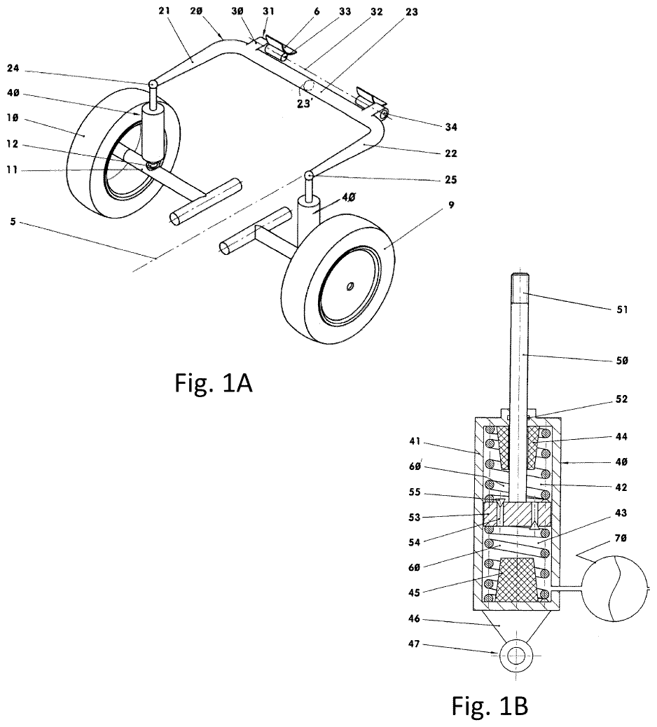

FIG. 2 illustrates a mechanical auxiliary device for stabilizing a vehicle with three or more wheels in accordance with some embodiments of the present invention.

FIG. 3 is a side view of the mechanical auxiliary device of the present invention.

### DETAILED DESCRIPTION OF THE FIGURES

The present invention is of a mechanical auxiliary device 200 for stabilization of free tilting suspension vehicles with three or more wheels by means of suspension damping and a free tilting mechanism.

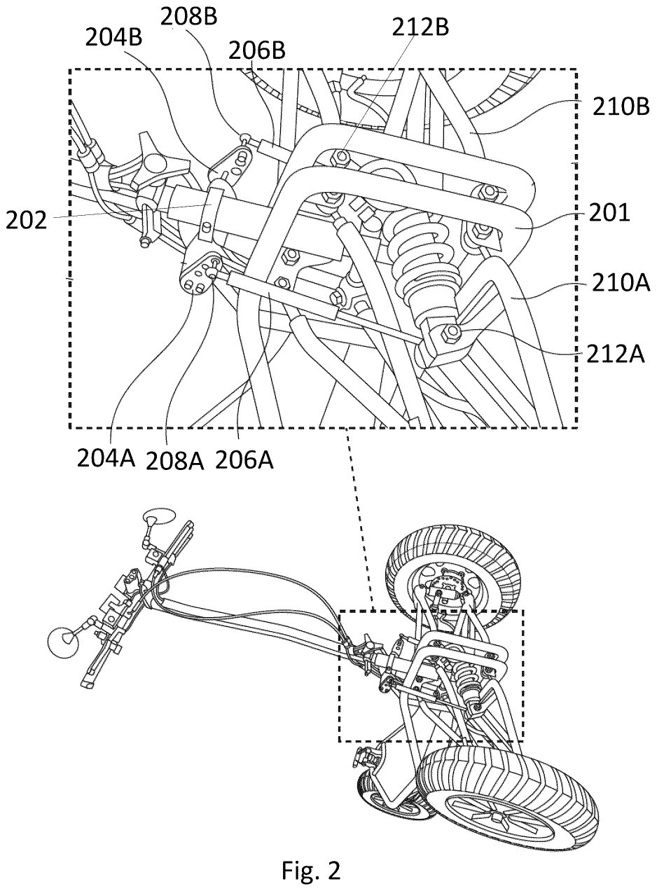

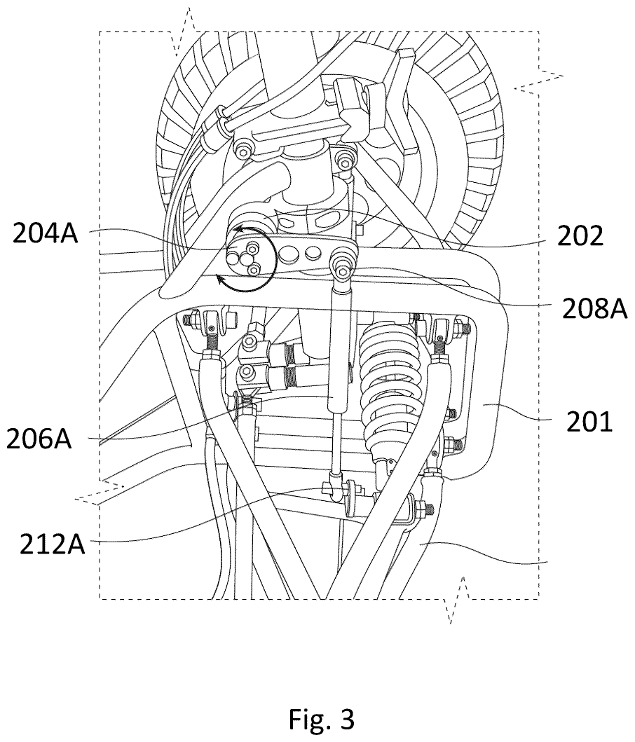

FIG. 2 illustrates a mechanical auxiliary device 200 for actively stabilizing a vehicle 201 with three or more wheels in accordance with some embodiments of the present invention, and FIG. 3 is a side view of the mechanical auxiliary device 200 of the present invention.

In accordance with some embodiments of the present invention, the mechanical auxiliary device 200 comprises a transverse shaft 202, a first, right, torque arm 204A and a second, left, torque arm 204B, a first, right, primed spring-type element, such as, for instance, first, right, primed spring-type piston 206A and a second, left, primed spring-type element, such as, for instance, second, left, primed spring-type piston 206B, and a first, right, suspension arm 210A and a second, left, suspension arm 210B.

In accordance with some embodiments of the present invention, the first, right, primed spring-type element and the second, left, primed spring-type element, may be gas pistons, spring pistons, spring-type scissor hinges and the like.

Thus, the spring-type pistons shown and described in the figures may be replaced by spring-type scissors hinges in accordance with some embodiments of the present invention.

In accordance with some embodiments of the present invention, the mechanical auxiliary device 200 is not active, but has a primed force that is operable independently.

In accordance with some embodiments of the present invention, each of the primed spring-type pistons 206A and 206B (or the primed spring-type scissor hinger) has equal torque throughout its length and has a sufficiently long stroke with respect to the length of the primed spring-type cylinder.

In accordance with some embodiments of the present invention, each of the primed spring-type piston 206A and the primed spring-type piston 206B may be a gas piston, a spring piston and the like.

In accordance with some embodiments of the present invention, each of the primed spring-type piston 206A and the primed spring-type piston 206B may be either normally open or normally close pistons.

In accordance with some embodiments of the present invention, the normally open/normally close primed spring-type pistons are essential elements of the stabilization system of the present invention. In accordance with some embodiments of the present invention, the transverse shaft 202 is mounted on the vehicle body. The transverse shaft 202 is oriented transversely to the vehicle 201 longitudinal direction.

The first, right, torque arm 204A and the second, left, torque arm 204B each connected to opposite ends of said transverse shaft 202.

Each of the first, right, primed spring-type piston 206A and the second, left, primed spring-type piston 206B is connected at its proximal end to a first, right, torque arm 204A and a second, left, torque arm 204B respectively.

The first, right, primed spring-type piston 206A is connected to the proximal end of the first, right, torque arm 204A through a first, right, joint connector 208A, and the second, left, primed spring-type piston 206B is connected to the proximal end of the second, left, torque arm 204B through a second, left, joint connector 208B.

The first, right, torque arm 204A and the second, left, torque arm 204B are connected at their ends laterally to a transverse shaft 202, at both ends of the transverse shaft 202 which is mounted on the vehicle body.

Each of the first, right, primed spring-type piston 206A and the second, left, primed spring-type piston 206B is connected at its distal end to a first, right, suspension arm 210A and a second, left, suspension arm 210B respectively.

The first, right, primed spring-type piston 206A is connected at its distal end to the first, right, suspension arm 210A by means of a third joint connector 212A, and the second, left, primed spring-type piston 206B is connected at its distal end to the second, left, suspension arm 210B by means of a forth joint connector 212B.

According to some embodiments of the present invention, while tilting the vehicle 201 to one side, for example, to the right, the angle between the second, left, suspension arm 210B and the vehicle body 201 increases and accordingly the distance between the end joints, the second, left, joint 208B and the forth joint connector 212B, of the second, left, primed spring-type piston 206B increases.

In this case, since the second, left, primed spring-type piston 206B is open to the end of its natural stroke (normally open) and cannot be extended, the second, left, suspension arm 210B pulls through the second, left, primed spring-type piston 206B the second, left, torque arm 204B in a circular motion counterclockwise about the center of the transverse shaft 202.

Since the first, right, torque arm 204A is connected to the other side of the transverse shaft 202, the transverse shaft 202 rotates the first, right, torque arm 204A clockwise in a circular motion that presses through the first, right, joint connector 208A the first, right, primed spring-type piston 206A.

The first, right, primed spring-type piston 206A is pressed from its lower side also by the first, right, suspension arm 210A due to the reduction of the angle between the first, right, suspension arm 210A and the vehicle body 201.

The force exerted on the first, right, primed spring-type piston 206A aims to straighten the vehicle 201 back from a tilted position to a balanced position where the first, right, primed spring-type piston 206A and the second, left, primed spring-type piston 206B are unloaded.

According to some embodiments of the present invention, a left tilt will do the same thing symmetrically on the opposite side. Specifically, according to some embodiments of the present invention, while tilting the vehicle 201 to the left, the angle between the first, right, suspension arm 210A and the vehicle body 201 increases and so as the distance between the end joints, the first, right, joint 108A and the third joint connector 212A, of the first, right, primed spring-type piston 206A increases.

In this case, since the first, right, primed spring-type piston 206A is open to the end of its natural stroke (normally open) and cannot be extended, the first, right, suspension arm 210A pulls through the first, right, primed spring-type piston 206A the first, right, torque arm 204A in a circular motion counterclockwise about the center of the transverse shaft 202.

Since the second, left, torque arm 204B is connected to the other side of the transverse shaft 202, the transverse shaft 202 rotates the second, left, torque arm 204B clockwise in a circular motion that presses through the second, left, joint connector 208B the second, left, primed spring-type piston 206B.

The second, left, primed spring-type piston 206B is pressed from its lower side also by the second, left, suspension arm 210B due to the reduction of the angle between the second, left, suspension arm 210B and the vehicle body 201.

The force exerted on the second, left, primed spring-type piston 106B aims to straighten the vehicle 201 back from a tilted position to a balanced position where the second, left, primed spring-type piston 206B and the first, right, primed spring-type piston 206A are unloaded.

In contrast, in a parallel damping action of the first, right, suspension arm 210A and the second, left, suspension arm 210B (not in the case of tilting), the first, right, primed spring-type piston 206A and the second, left, primed spring-type piston 206B move freely in the (normally open/normally close) position and are not required due to the free movement made possible by the fact that they are connected through the transverse shaft 202 having the torque arms 204A and B.

It should be noted that if the first, right, primed spring-type piston 206A and the second, left, primed spring-type piston 206B were directly connected to the vehicle body 201 without the transverse shaft 202 and without the first, right, torque arm 204A and the second, left, torque arm 204B, the weight of the vehicle 201 and the rider would have passed through the two primed spring-type pistons, the first, right, primed spring-type piston 206A and the second, left, primed spring-type piston 206B, at the same time due to the natural sinking of the suspension. In this case, the force of the first, right, primed spring-type piston 206A and the second, left, primed spring-type piston 206B against each other cancels their effect to stabilize the vehicle 201 in a balanced state, therefore, an effective “lock” point would not be obtained in a balanced state

Also in such a case, the movement of the piston will limit the angle at which the vehicle can tilt on its side since the movement of the opposite rack in the direction of tilting is limited (“to open”) by the piston which is connected to it by the open end of the primed spring-type piston.

It should be noted that in this case, the movement of the piston (either the first, right, primed spring-type piston 206A or the second, left, primed spring-type piston 206B) will limit the angle at which the vehicle 201 can tilt on its side since the movement of the opposite suspension arm (the first suspension arm 210A or the second suspension arm 210B) in the direction of the tilt is limited by the piston that is connected to the suspension arm.

The advantage of the primed spring-type pistons 206A&B in the present invention is two-fold. The primed spring-type pistons 206A&B have (a) equal torque throughout their length and (b a sufficiently long stroke relative to the length of the primed spring-type cylinder. Therefore, the primed spring-type pistons allow the free tilt mechanism to be “locked” by the resistance force to tilting at the end of the pistons' stroke when the vehicle is standing in a straight position.

In accordance with some embodiments of the present invention, the mechanical auxiliary device 200 creates an auxiliary force which maintains the vehicle and the rider stable and balanced while the vehicle is standing, crawling, or traveling backwards while there is insufficient kinetic force to allow stability in the same way as for two-wheeled vehicles such as bicycles, motorcycles and the like.

Thus, the stabilization system of the present invention solves the critical problem of stabilizing a vehicle with a tilting mechanism in a straight position where the rider stands on it and does not lower his feet to the ground to stabilize it while standing, while traveling backwards and while crawling slowly.

1.-11. (canceled)

12. A mechanical auxiliary device for stabilization of free tilting suspension vehicles comprising:
a transverse shaft mounted on said vehicle body, said transverse shaft is oriented transversely to the vehicle longitudinal direction,
a first, right, torque arm and a second, left, torque arm each connected to opposite ends of said transverse shaft,
a first, right, primed spring-type element connected at its proximal end to said first, right, torque arm, and a second, left, a second, left, primed spring-type element connected at its proximal end to the second, left, torque arm, said first, right primed spring-type element is connected at its distal end to a first, right, suspension arm, and said second, left, primed spring-type element is connected at its distal end to a second, left, suspension arm, said first primed spring-type element and said second primed spring-type element are approximately vertically oriented to said transverse shaft,
wherein tilting the vehicle to the right increases an angle between the second, left, suspension arm and the vehicle body and causing the transverse shaft to rotate the first, right, power arm clockwise in a circular motion, thus, exerting force on, and thus, pressing, the first, right, primed spring-type element, as a result of which straightening the vehicle back from a tilted position to a balanced position, and
wherein tilting the vehicle to the left increases an angle between the first, right, suspension arm and the vehicle body and causing the transverse shaft to rotate the second, left, torque arm counterclockwise in a circular motion, thus, exerting force on, and thus, pressing, the second, left, primed spring-type element, as a result of which straightening the vehicle back from a tilted position to a balanced position.

13. The mechanical auxiliary device of claim 12, wherein the first, right, primed spring-type element and the second, left, primed spring-type element are selected from primed spring-type pistons and primed spring type scissors hinges.

14. The mechanical auxiliary device of claim 13, wherein each of the primed spring-type pistons is selected from a gas piston and a spring piston.

15. The mechanical auxiliary device of claim 12, wherein the first, right, primed spring-type element is connected to the first, right, torque arm through a first, right, joint connector.

16. The mechanical auxiliary device of claim 12, wherein the second, left, primed spring-type element is connected to the second, left, torque arm through a second, left, joint connector.

17. The mechanical auxiliary device of claim 12, wherein the first, right, primed spring-type element is connected at its distal end to the first, right, suspension arm by means of a third joint connector.

18. The mechanical auxiliary device of claim 12, wherein the second, left, primed spring-type element is connected at its distal end to the second, left, suspension arm by means of a forth joint connector.

19. The mechanical auxiliary device of claim 12, wherein tilting the vehicle to the right increasing the distance between the second, left, joint connector connecting the primed spring-type element to the second, left, torque arm and the forth joint connector connecting the distal end of the second, left, primed spring-type element to the suspension arm.

20. The mechanical auxiliary device of claim 12, wherein tilting the vehicle to the left increasing the distance between the first, right, joint connector connecting the primed spring-type element to the first, right, torque arm and the third joint connector connecting the distal end of the second, right, primed spring-type element to the suspension arm.

21. The mechanical auxiliary device of claim 12, wherein tilting the vehicle to the right, the second, left, primed spring-type element is open to the end of its natural stroke and cannot be extended, thus, the second, left, suspension arm pulling through the second, left, primed spring-type element, the second, left, torque arm in a circular motion counterclockwise about the center of the transverse shaft.

22. The mechanical auxiliary device of claim 12, wherein tilting the vehicle to the left, the first, right, primed spring-type element is open to the end of its natural stroke and cannot be extended, thus, the first, right, suspension arm pulling through the first, right, primed spring-type element the first, right, torque arm in a circular motion clockwise about the center of the transverse shaft.
